(19) United States
(12) Patent Application Publication
(10) Pub. No.: US 2004/0044543 A1
(43) Pub. Date: Mar. 4, 2004

(54) Method and system of producing a landscape plan

(76) Inventor: Christopher Morgan Rowden, Atlanta, GA (US)

Correspondence Address: Song K. Jung, MCKENNA LONG & ALDRIDGE LLP, 1900 K Street, N.W., Washington, DC, 20006, US

(21) Appl. No.: 10/627,671

(22) Filed: Jul. 28, 2003

Related U.S. Application Data
(63) Continuation of application No. 09/654,571, filed on Sep. 1, 2000.

(51) Int. Cl. G06F 17/60

(52) U.S. Cl. 705/1

(57) ABSTRACT

A process for producing a landscape plan for a property uses a set of predefined unique symbols, each corresponding to a generic landscape element. The landscape plan uses the symbols to indicate the locations on the property where various generic landscape elements are to located. Landscape elements include not only plants, but hardscape elements such as retaining walls, sidewalks, driveways, patios, pools, ponds, etc. Generic plant categories are also defined according to plant size and leaf texture. Symbols are assigned for hardscape elements according to a type of material to be used. A customer communicates information regarding the property to a landscape architect, preferably via the Internet. The information includes a survey of the property, a photograph of the property, and a list of desired landscape characteristics for the property.

### BACKGROUND OF THE INVENTION

1) Field of the Invention

This invention pertains to the field of landscape planning and, more particularly, to a method and system of producing a non-specific landscape plan.

2) Description of the Related Art

Landscape planning has been called the art of arranging the environment to support human behavior. Landscape plans are design-drawings that show the boundaries, outlines, dimensions, contours, positions, and other characteristics of a defined area and its structures, remaining natural vegetation, and plantings. When drawing a landscape plan, one draws a symbol for each plant, and identifies it by genus, species, and if applicable, variety.

Landscape plans are produced by landscape architects who are typically licensed in the state(s) in which they practice. Most landscape architects have been through a college program of at least four years, and are required to pass a complex test that requires knowledge in many areas of landscaping. Typically, the landscape architect will be knowledgeable about site planning, grading, drainage, hardscapes, irrigation systems, lighting and plant materials. As there are many differences in the trees, plants, shrubs, grasses, etc. that grow in different states and geographical regions, it is usually impractical for a landscape architect to be licensed or practice in all states.

In many smaller communities, there may be no locally available landscape architect. Moreover, landscape planning can be relatively expensive, with fees of up to $100/hour not uncommon.

Accordingly, it would be advantageous to provide an improved system and method of landscape design and producing landscape plans. It would also be advantageous to provide such a system and method which facilitates the production of landscape plans from landscape architects licensed in and located in states which are remote from the property for which the plan is produced. It would be still further advantageous to provide such a system and method which facilitates the production of landscape plans by a landscape architect for properties located in geographical areas with which the architect is unfamiliar. It would be still further advantageous to provide such a system and method which can reduce the costs of producing a landscape plan. Other and further objects and advantages will appear hereinafter.

### SUMMARY OF THE INVENTION

The present invention comprises a system and method of producing a landscape plan.

In one aspect of the invention, a process for producing a landscape plan comprises creating a set of generic plant categories, assigning a unique symbol to each generic plant category, and producing the landscape plan by indicating locations for plants using said symbols.

In another aspect of the invention, a process for producing a landscape plan comprises creating a set of symbols each corresponding to a generic landscape element, and producing the landscape plan by indicating locations for generic landscape elements using said symbols. Landscape elements include not only plants, but hardscape elements such as retaining walls, sidewalks, driveways, patios, pools, ponds, etc.

In yet another aspect of the invention, a process for producing a landscape plan for a property comprises creating a set of generic plant categories, assigning a unique symbol to each generic plant category, communicating from a customer to a landscape architect a survey of the property, a photograph of the property, and a list of desired landscape characteristics for the property, and producing the landscape plan for the property, the landscape plan using the symbols to indicate locations where plants should be located.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

FIG. 1 is a flowchart for producing a landscape plan;

FIG. 2 is an exemplary plat map for a property;

FIG. 3 is an exemplary landscape plan according to one or more aspects of the present invention;

FIG. 4 is a legend of landscape elements for the landscape plan shown in FIG. 3.

### DESCRIPTION OF THE PREFERRED EMBODIMENTS

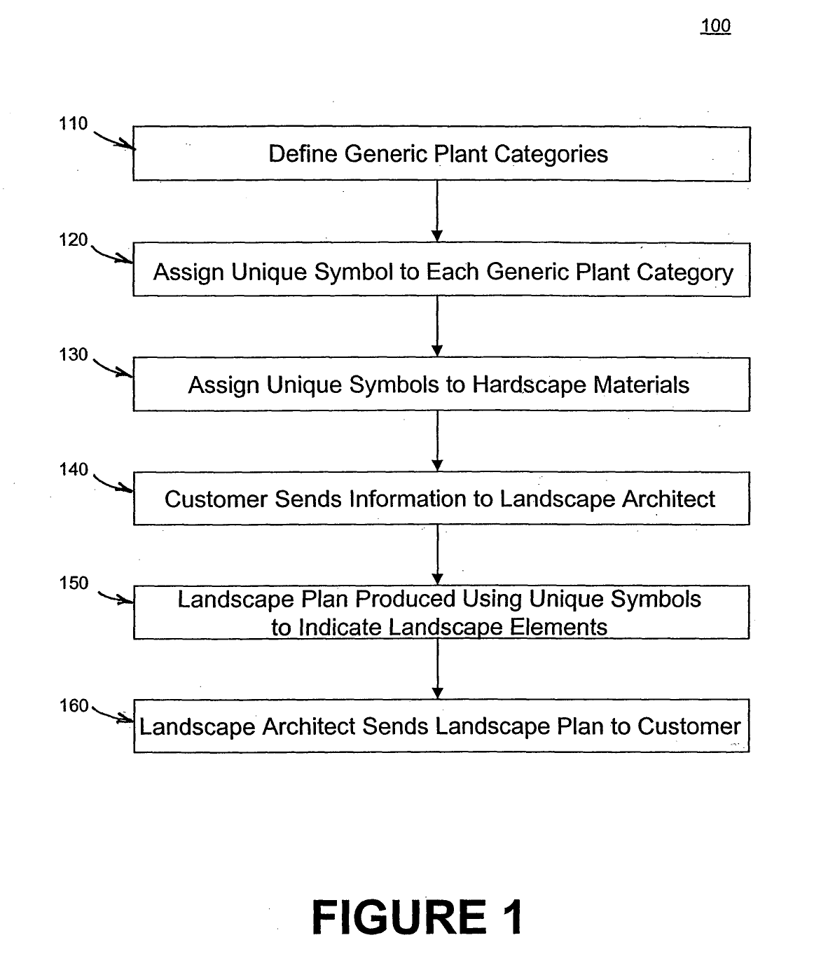

A preferred embodiment process for producing a landscape plan will be described now with respect to FIGS. 1-4. In the preferred embodiment process, a landscape architect communicates information with a customer via the Internet. However, unique aspects and features of the present invention may be achieved even when communication between a landscape architect and a customer is conducted entirely by telephone and/or regular mail.

FIG. 1 illustrates a flowchart 100 for a preferred embodiment of a process for producing a landscape plan for a property.

In a first step 110 a number of generic plant categories are defined. Generic plant categories may be defined based upon plant height, plant diameter or spread, leaf size (a.k.a. “texture”), and whether the plant is deciduous or evergreen. In a preferred embodiment, plants are divided as shown in Table 1.

TABLE 1

| TYPE | SIZE | LEAF TEXTURE |
|---|---|---|
| Shrub | <36″ | Small |
| Shrub | <36″ | Medium |
| Shrub | <36″ | Large |
| Shrub | 36″ to 72″ | Small |
| Shrub | 36″ to 72″ | Medium |
| Shrub | 36″ to 72″ | Large |
| Shrub | >72″ | Small |
| Shrub | >72″ | Medium |
| Shrub | >72″ | Large |
| Tree | <20′ | — |
| Tree | 20′ to 50′ | — |
| Tree | >50′ | — |

Moreover, the plants of Table 1 may be further divided into deciduous plants, and evergreen plants to produce up to 24 generic plant categories. Thus, a number of predefined generic plant categories are established.

In a second step 120, a unique symbol is assigned to-each generic plant category. The unique symbols may be geometric shapes, such as triangles, circles, squares, hexagons, etc. or various sizes and/or colors. Alternatively, the symbols may be graphical images, such as a generic tree image, a generic shrub image, etc. The unique symbols are to be used in drawing the landscape plan to indicate where various plants belonging to the generic plant categories should be located on the property.

The unique symbols may have two variations, one for indicating an evergreen plant and a second for indicating a deciduous plant. In a preferred embodiment, a letter “E” or “D” may be associated with each unique symbol to indicate whether a plant is an evergreen or deciduous, respectively.

In a third step 130, unique symbols are assigned to materials used for various hardscape elements. Hardscape elements may include retaining walls, sidewalks, driveways, patios, pools, ponds, etc. A unique symbol may be assigned for each different material, such as brick, stone, concrete, asphalt, etc. In the preferred embodiment process, landscape plans are produced which do not specify a specific type, color, or pattern of the materials used.

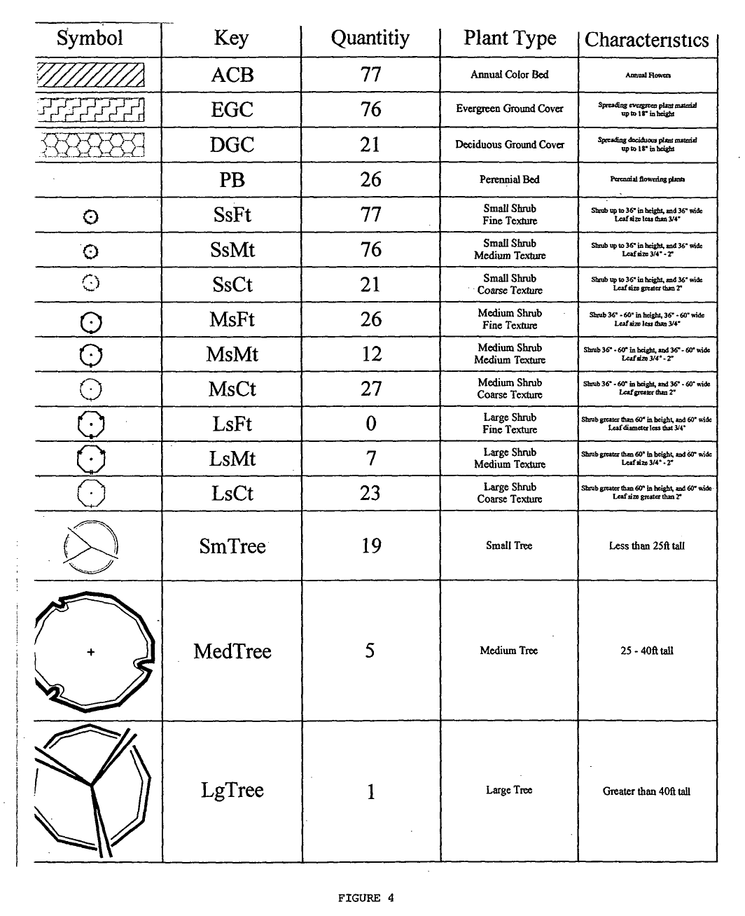

Thus, through the steps 110-130, a set of unique symbols is created, with each unique symbol corresponding to a generic landscape element, where a generic landscape element may be a plant or a hardscape element. FIG. 4 illustrates an embodiment of a legend of unique symbols representing generic landscape elements in a landscape plan according to one or more aspects of the present invention.

In a fourth step 140, a customer communicates to a landscape architect both customer information and information regarding a property for which the customer wants a landscape plan to be prepared.

In a preferred embodiment, the customer contacts the landscape architect via a computer connected to a landscape plan Web site. In that case, the Web site may transmit to the customer's computer a “customer information questionnaire” Web form, including data entry boxes for the customer to enter his/her name and contact information, such as mailing address, fax number, e-mail address, etc. Preferably, the customer information questionnaire web form includes one or more data entry boxes for the customer to supply billing information, such as a credit card number and expiration date.

The customer completes the customer information questionnaire and transmits the completed customer information questionnaire back to the landscape plan Web site. Alternatively, the customer may manually fill out the customer information questionnaire and send it by mail or fax back to an address or fax number supplied by the landscape plan Web site.

The landscape plan Web site also transmits to the customer's computer a property information questionnaire, including questions regarding features or characteristics which the customer desires in the landscape plan. Preferably, the property information questionnaire includes a list of various elements (e.g., pool, deck, retaining walls, sidewalks, driveway, lighting, drainage, plants, etc.) and the customer clicks on boxes next to each desired element.

The customer completes the property information questionnaire and transmits the completed property information questionnaire back to the landscape plan Web site. Alternatively, the customer may manually fill out the property information questionnaire and send it by mail or fax back to an address or fax number supplied by the landscape plan Web site.

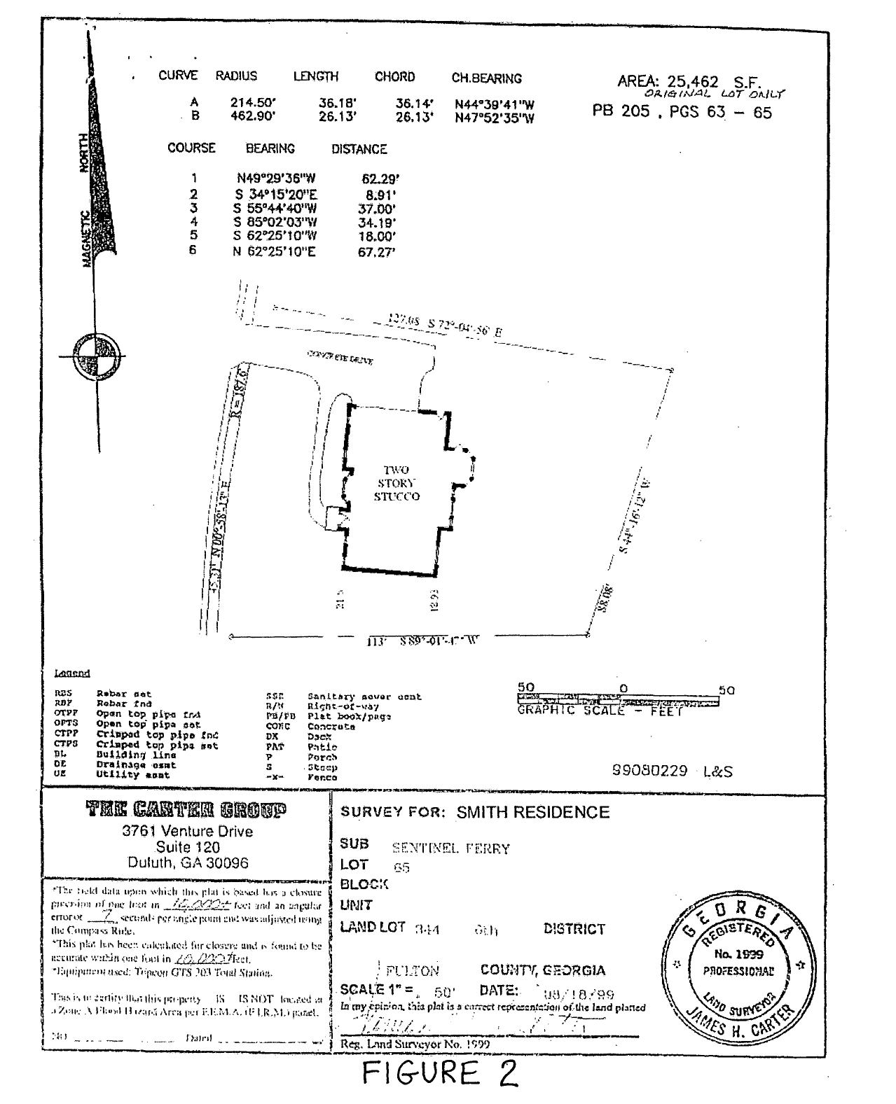

In the preferred embodiment, the landscape plan Web site transmits an instructions Web page to the customer's computer listing additional information which the customer needs to furnish for the landscape plan to be produced. The customer is instructed to supply a property survey or plat map, and at least one photograph of the property. FIG. 2 shows an exemplary plat map which may be supplied by a customer. Preferably, the instructions Web page also includes instructions for the customer to take pictures of the property, describing the preferred vantage points and how the pictures should be ordered or labeled. The Web site may also transmit to the customer an e-mail address where the customer may send the required information regarding the property, including the property survey and photographs. Alternatively, the customer may send the required information regarding the property, including the property survey and photographs, by mail or fax back to an address or fax number supplied by the landscape plan Web site.

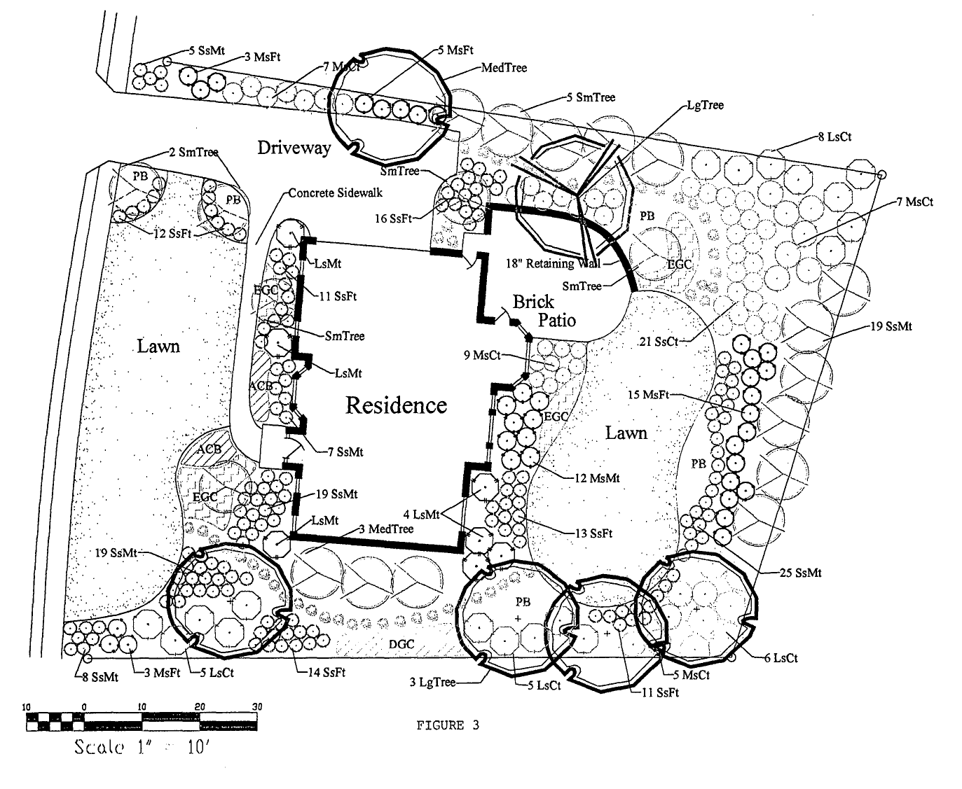

In a fifth step 150, the landscape architect generates a generic landscape plan for the property from the property survey and the photographs. FIG. 3 shows an exemplary landscape plan 300 generated using symbols to represent landscape elements. The landscape plan 300 includes a plurality of landscape elements, each shown as a unique symbol according to the legend shown in FIG. 4. For example, the landscape plan includes a symbol for each plant, indicating its location on the property. The unique symbol chosen indicates a generic plant category to which the plant belongs. Similarly, the landscape plan shows the location, size, and shape of various hardscape elements, and uses symbols to indicate a general type of material to be used (e.g., “brick”), but does not specify the exact material by color, pattern, etc.

In a preferred embodiment, the landscape plan supplied by the landscape architect includes a legend, such as the legend shown in FIG. 4 for example, identifying a generic landscape element corresponding to each unique symbol included on the plan. Preferably, the landscape plan also includes some general notes that may further assist the customer to select the particular plants and materials to be used to implement the landscape plan (e.g., information on desired flower colors, fragrances, etc.).

Also, in a preferred embodiment, the landscape plan has associated therewith a list of plants that belong to the each of the generic plant categories identified by a symbol on the landscape plan. In a preferred embodiment, the landscape plan Web site includes a general list of plants that belong to the each of the generic plant categories. The list may also include pictures of some or all of the plants. The list may be used by the customer to help choose an appropriate plant based upon the symbols indicated on the landscape plan, even though some or all of the plants may be unavailable in the area where the customer's property is located.

In a step 160, the landscape architect communicates the landscape plan, including the legend, to the customer. In a preferred embodiment, the landscape plan is sent to an e-mail address specified by the customer in the step 140 above. Alternatively, the landscape plan Web site may include individual Web pages for each customer to log-in and retrieve their landscape plan. Or the landscape plan may be sent by regular mail or facsimile to the customer.

When the customer receives the landscape plan, he/she can take it to a local nursery and/or building material supply center to select the particular plants and materials to be used to implement the landscape plan. The description of the generic landscape element corresponding to each symbol in the legend will guide the customer to selecting appropriate plants and materials.

Through the present invention, many benefits are possible. A plan may be produced by a landscape architect operating in a distant region of the country from where a property is located, even when the landscape architect is completely unfamiliar with exactly what plants are available in the area. Moreover, because the landscape architect does not have to specify particular plants and hardscape materials, the cost of preparing the landscape plan can be significantly reduced.

While preferred embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

What is claimed is:

1. A process for producing a landscape plan for a property, comprising:
defining a set of generic plant categories;
assigning a corresponding unique symbol to each generic plant category, defining a set of unique symbols;
receiving from a customer a survey of the property, a photograph of the property, and a list of desired landscape characteristics for the property; and
generating the landscape plan for the property, the landscape plan using the unique symbols to indicate locations on the property where plants should be located.

2. The process of claim 1, wherein the generic plant categories are defined according to a plant size.

3. The process of claim 2, wherein the generic plant categories are defined according to a leaf texture.

4. The process of claim 1, wherein the set of generic plant categories are divided into a first subset of plant categories corresponding to deciduous plants, and a second subset of generic plant categories corresponding to evergreen plants.

5. The process of claim 4, wherein the unique symbols identify the deciduous plants and the evergreen plants.

6. The process of claim 1, further comprising assigning a second set of unique symbols each corresponding to a type of hardscape material, wherein the landscape plan uses the second set of unique symbols to indicate hardscape materials to be used for hardscape elements indicated on the landscape plan.

7. The process of claim 1, wherein the landscape plan includes a legend identifying each symbol.

8. The process of claim 1, further comprising providing a list of specific plants belonging to each generic plant category.

9. A process for producing a landscape plan for a property, comprising:
defining a set of generic plant categories;
assigning a symbol to each generic plant category; and
producing the landscape plan by indicating via said symbols locations for plants on said property.

10. The process of claim 9, wherein the generic plant categories are defined according to a plant size.

11. The process of claim 10, wherein the generic plant categories are defined according to a leaf texture.

12. The process of claim 9, wherein the set of generic plant categories are divided into a first subset of plant categories corresponding to deciduous plants, and a second subset of generic plant categories corresponding to evergreen plants.

13. The process of claim 12, wherein the unique symbols identify the deciduous plants and the evergreen plants.

14. The process of claim 9, further comprising assigning a second set of unique symbols each corresponding to a type of hardscape material, wherein the landscape plan uses the second set of unique symbols to indicate hardscape materials to be used for hardscape elements indicated on the landscape plan.

15. The process of claim 9, wherein the landscape plan includes a legend identifying each symbol.

16. The process of claim 9, further comprising providing a list of specific plants belonging to each generic plant category.

17. A process for producing a landscape plan for a property, comprising:
defining a set of symbols, each symbol corresponding to a generic landscape element, and
producing the landscape plan by indicating via said symbols locations for the generic landscape elements on said property.

18. The process of claim 17, wherein the set of symbols includes a first subset of symbols corresponding to a set of generic plant categories, and a second subset of symbols corresponding to a type of hardscape material.
